(19) United States
(12) Patent Application Publication
(10) Pub. No.: US 2014/0104053 A1
(43) Pub. Date: Apr. 17, 2014

(54) VEHICLE OCCUPANCY AND RESTRAINT STATUS INDICATION AND DRIVER DISTRACTION SYSTEM

(71) Applicant: Benjamin T. Clark, JR., South Bend, IN (US)

(72) Inventor: Benjamin T. Clark, JR., South Bend, IN (US)

(21) Appl. No.: 13/653,139

(22) Filed: Oct. 16, 2012

(51) Int. Cl. B60Q 1/00

(52) U.S. Cl. 340/457.1

(57) ABSTRACT

The occupancy and restraint status indicator system (ORSIS) includes a control module wired to the restraint sensors and pressure sensors embedded in each vehicle seat and an externally visible light panel wired to the control module. The control module interprets the signal from the pressure and restraint sensors and displays the occupancy and restraint status of each seat on the light panel. The ORSIS provides an external display and communicates the occupancy and restraint status of a vehicle to approaching law enforcement personnel and first responders.

This invention relates to an electrical system for indicating the occupancy and safety restraint status of a vehicle and for enhancing driver safety by reducing distractions.

### BACKGROUND AND SUMMARY OF THE INVENTION

Every traffic stop presents a potential danger to law enforcement officers. When enforcing even minor vehicle infractions, such as the required use of safety restraints, the officer must approach the vehicle. Because tinted glass obscures the vehicle interior, an approaching law enforcement officer often is unaware of the number and location of vehicle occupants. The use of safety restraints is required by most states. In addition, in many states, young drivers are prohibited from operating a vehicle with a passenger. Tinted glass prevents officers from monitoring the occupancy of a vehicle and determining if those occupants are wearing their safety restraints. Knowing the number and location of each occupant is also critical for first responders arriving at the scene of a vehicle accident.

The use of electronics in vehicles for telecommunication and entertainment also presents dangers for law enforcement and first responders. Motorist, as well as law enforcement officers and first responders are also endangered when sirens cannot be heard inside the passenger compartments of vehicles. The sirens that provide an audible alarm indicating to the presence of an approaching police car or emergency vehicle often cannot be heard over the music of a vehicle's sound system. In addition, drivers are frequently distracted in the operation of a vehicle by mobile phones and other electronic devices that are readily available in conventional motor vehicles.

The present invention provides an electronic system for externally displaying and communicating the occupancy and restraint status of a vehicle to approaching law enforcement personnel and first responders. The occupancy and restraint status indicator system (ORSIS) of this invention includes a control module wired to the restraint sensors and pressure sensors embedded in each vehicle seat and an externally visible light panel wired to the control module. The control module interprets the signals from the pressure and restraint sensors and displays the occupancy and restraint status of each seat on the light panel. The ORSIS may also include a transmitter for communicating the occupancy and restraint status to a remote receiver, which may be accessed by law enforcement personnel and first responders. The ORSIS gives the officer or first responder a visual indication of the seat location of each occupant of a vehicle without approaching the vehicle. The ORSIS gives a visual indication that all or any of the occupants are wearing their safety restraints. The ORSIS may also include electrical components, receivers and circuitry for enhancing the driver's situational awareness and reducing driver distractions. In certain embodiments the ORSIS includes system components that automatically mute the vehicle sound system when emergency vehicles are approaching and block telecommunication signals, thereby preventing the use of cell phones and the like while the vehicle is operating.

These and other advantages of the present invention will become apparent from the following description of an embodiment of the invention with reference to the accompanying drawings.

### BRIEF DESCRIPTION OF THE DRAWINGS

The drawings illustrate an embodiment of the present invention, in which:

FIG. 1 is a simplified perspective view of a vehicle showing the basic wiring schematic of an embodiment of the occupancy and restraint status indicator system (ORSIS) of this invention;

FIG. 2 is a simplified plan view of a vehicle showing the basic wiring schematic of an embodiment of the occupancy and restraint status indicator system (ORSIS) of FIG. 1;

FIG. 3 is a simplified schematic of a vehicle showing the basic wiring schematic of an embodiment of the occupancy and restraint status indicator system (ORSIS) of FIG. 1;

FIG. 4 is a simplified perspective view of a vehicle showing the basic wiring schematic of a second embodiment of the occupancy and restraint status indicator system (ORSIS) of this invention;

FIG. 5 is a simplified plan view of a vehicle showing the basic wiring schematic of an embodiment of the occupancy and restraint status indicator system (ORSIS) of FIG. 4;

FIG. 6 is a simplified schematic of a vehicle showing the basic wiring schematic of an embodiment of the occupancy and restraint status indicator system (ORSIS) of FIG. 4;

FIG. 7 is a simplified perspective view of a vehicle showing the basic wiring schematic of a third embodiment of the occupancy and restraint status indicator system (ORSIS) of this invention; and

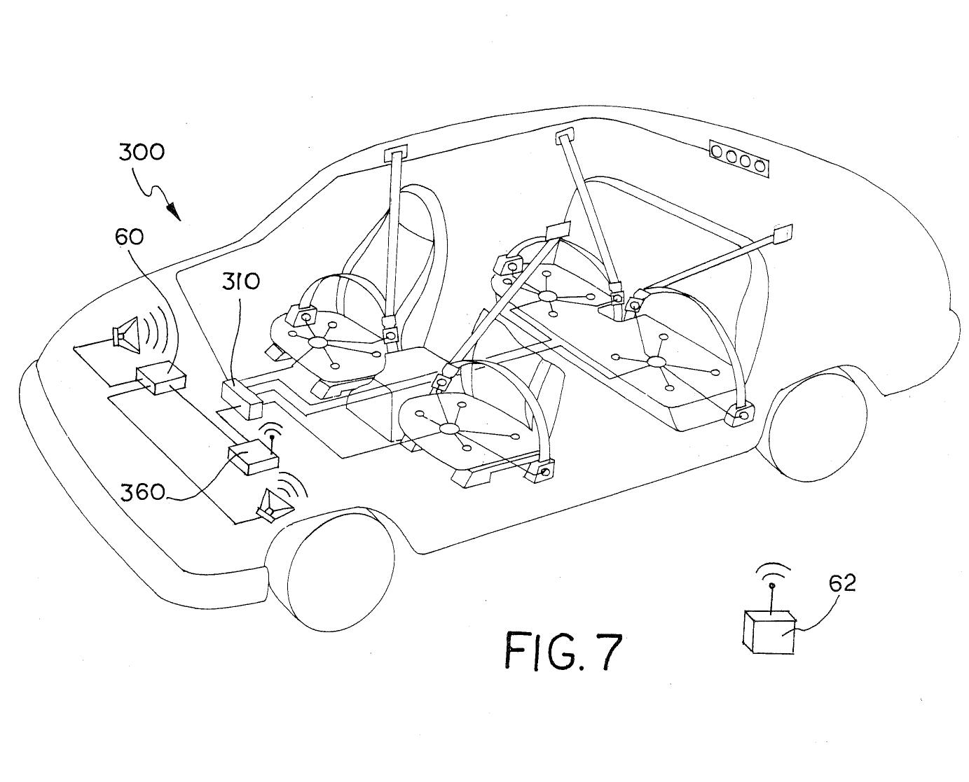

FIG. 8 is a simplified perspective view of a vehicle showing the basic wiring schematic of a fourth embodiment of the occupancy and restraint status indicator system (ORSIS) of this invention.

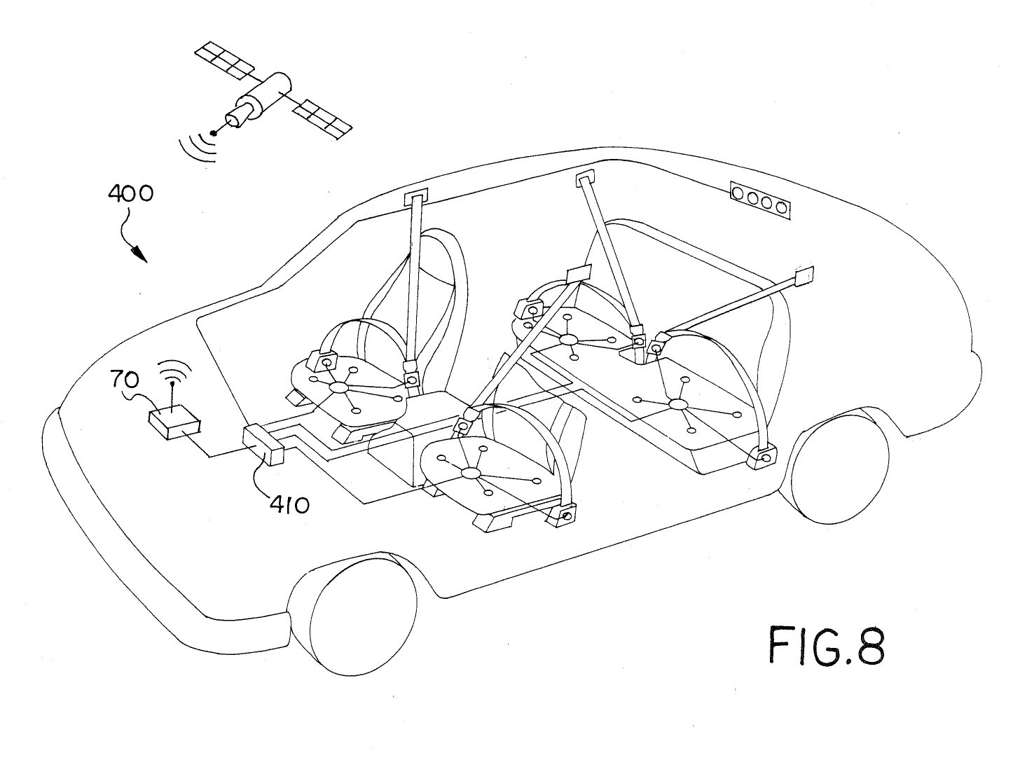

### DESCRIPTION OF THE PREFERRED EMBODIMENT

The occupancy and restraint status indicator system (ORSIS) of this invention is designed to provide law enforcement and first responders a visible indication of the number and location of occupants in a vehicle, as well as the status of each seat's safety restraint. In certain embodiments, the ORSIS is electrically connected to the vehicles existing restraint control modules (RCM) and occupancy classification system (OSC) and uses the electrical signals from those system's pressure sensors and safety restraint sensors to generate a visible indication of the seating positions of the occupants and the status of their safety restraints. In other embodiments, the ORSIS is directly integrated into the vehicle's electrical systems and includes the actual RCM and OSC circuitry. Other embodiments of this invention may take the form of a completely separate and independent electrical system having its own pressure sensors, restraint sensors, control modules, and status displays and alarms, as well as, having its own power supply and logic controls.

In the automobile industry, restraint control modules and occupancy classification systems are well known and in common use. Typically, restraint control modules (RCMs) control the deployment of air bags in the event of a collision. Occupancy classification systems are an additional electrical system that detect whether an occupant in a seat is an adult or child, which eliminates the need for an air bag on/off switch. RCM and OCS and similar electrical systems are well known in the automobile industry. RCM and OCS use a variety of pressure sensors embedded within the vehicle seat themselves. These pressure sensors detect the weight of a person occupying a particular vehicle seat. Various types of sensors may be used for this purpose including, pressure pads, pressure bolts, strain gauges, and the like. Some vehicles also employ optical sensors to detect the presence of a seated occupant. Similarly, RCM and OCS use various restraint sensors, including safety belt tension sensors and restraint latch sensors to detect whether the safety restraint (seat belt) is properly fastened. These types of pressure sensors, restraint sensors and other such similar detection devices are well known and may be incorporated into any embodiment of the ORSIS as desired and applicable.

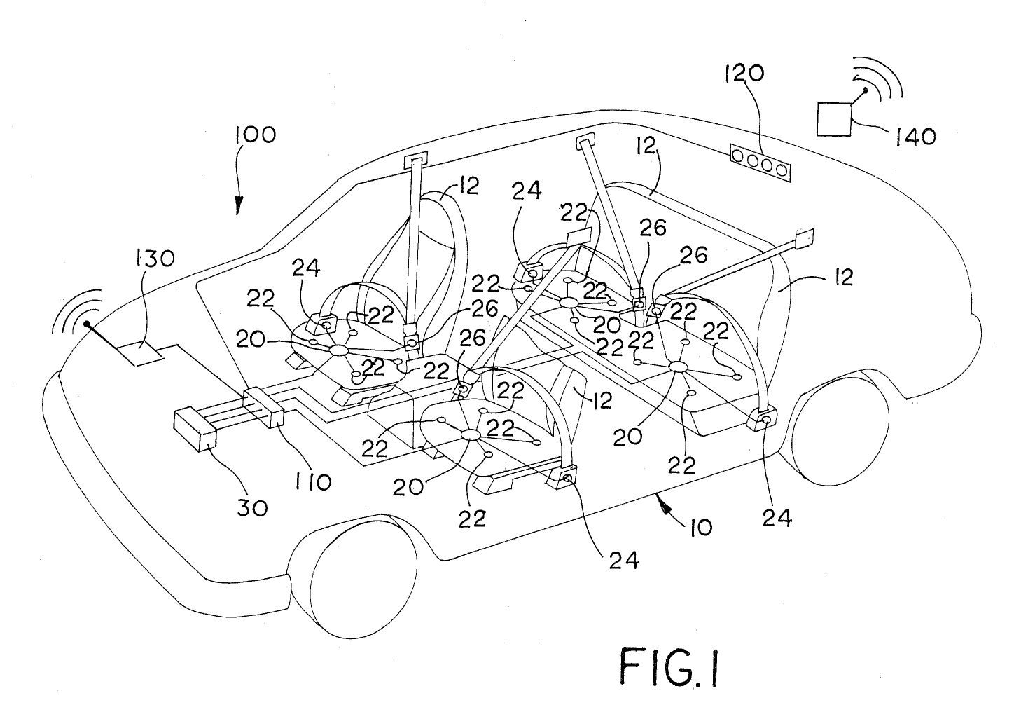

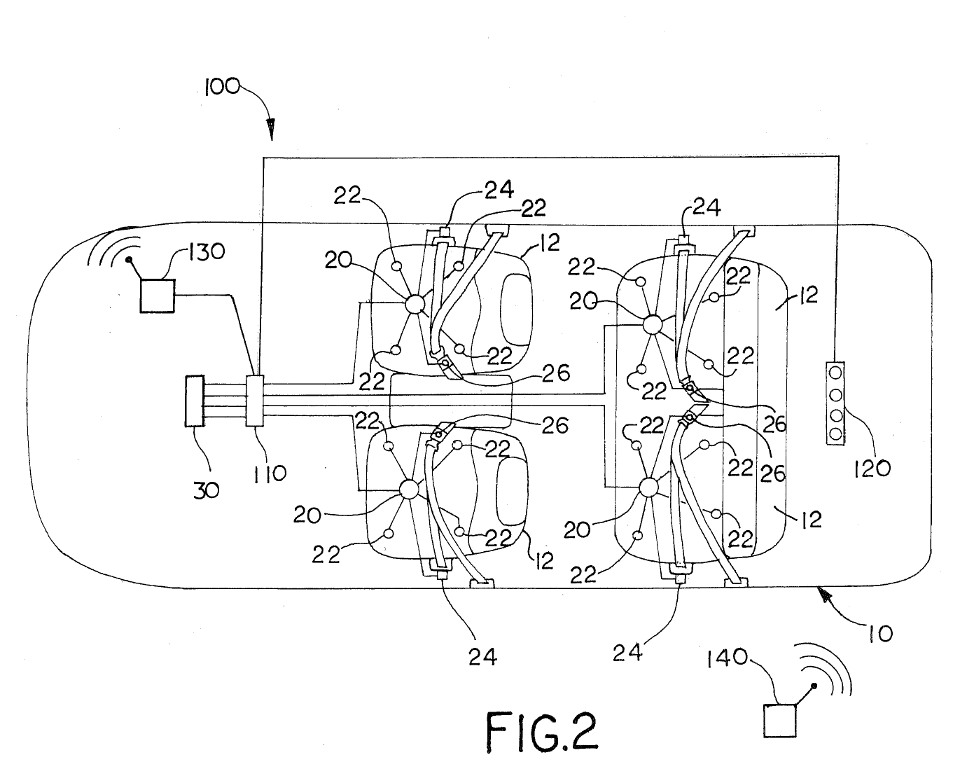

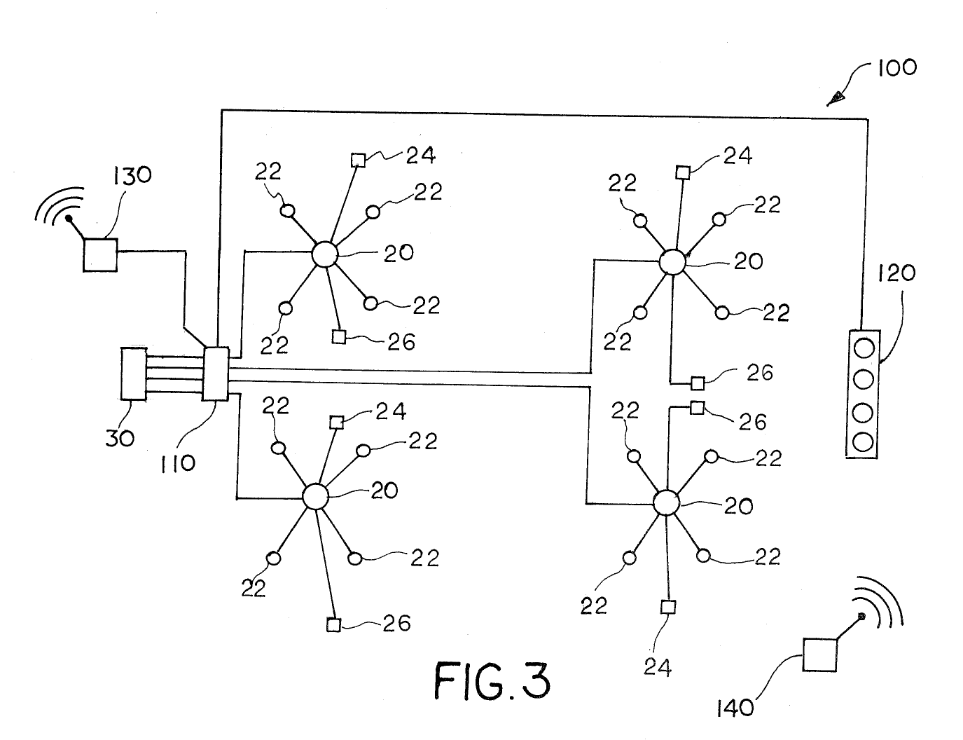

Referring now to the drawings and schematics, FIGS. 1-3 illustrate a typical vehicle 10 and an embodiment of the occupancy and safety restraint status indication system (ORSIS) of this invention, which is generally designated as reference numeral 100. In this embodiment, ORSIS 100 is electrically wired into the vehicle's electrical system and directly to restraint control module (RCM) 30 and occupancy classification system (OCS) 40 as an after market accessory. Each component of ORSIS 100 is typically wired into the vehicle's existing internal electrical system for their power supply needs, although certain embodiments may be self powered by batteries or connected to alternative power sources as desired. ORSIS 100 includes an occupancy/restraint status indicator (ORSI) module 110 and one or more externally visible light panels 120. ORSI module 110 is electrically wired to the RCM 20 of each seat and the vehicle's OSC 140. Each seat 12 includes four bolt pressure sensors 22 , a seat belt tension sensor 24 and a seat belt latch sensor 26, all of which are electrically wired to a restraint control module (RCM) 20. Pressure sensors 22, a seat belt tension sensor 24 and a seat belt latch sensor 26 through the RCM 20 provide the electrical input signals for ORSI module 110 for each seat 12. ORSI module 110 generates an output electrical signal to light panel 120. ORSI module 110 generally is a microprocessor based logic control that uses the electrical signals from each of the seat's RCM to light panel 120 for visually displaying the occupancy and restraint status of each seat. It should be noted that ORSI module 110 does not alter the normal operation of the RCM or OSC, but allows the electrical signal from each RCM to pass through on to the OCS.

Light panels 120 are mounted to the vehicle's exterior at various locations. Typically, at least one light panel is mounted to be visible from the rear of the vehicle. Light panel 120 may assume a variety of configurations and may be located at any desirable place on the vehicles exterior or interior. In certain embodiments, the light panels may be add-on components mounted to the vehicle exterior. In other embodiments, the light panel may be integrated in the vehicles existing lights, such as the center rear brake lights, side view and rearview mirrors and/or tail lights. As shown, light panel 120 includes an array of LED or incandescent lights 122 with each light corresponding to each of the vehicles seats. In certain embodiments, a light corresponding to each seat will illuminate when a person occupies that seat. The same light may illuminate in a different color when that seat's restraint is activated or another corresponding light may illuminate. Other embodiments may use any other variety of illumination scheme to visually indicate the occupancy and restraint status of the vehicle.

ORSIS 100 also includes a signal transmitter 130 connected to the ORSI module110, which can communicate occupancy and restraint status to a remote receiver 140, accessible to law enforcement and first responders. Transmitter 130 and remote receiver 140 can employ any suitable data signal transmission technology, including but not limited to radio frequency (RF), infrared, WiFi, Blue Tooth® or similar technologies. Remote receiver 140 can be hand held devices, such as radios, radar guns, smart phones, laptops or similar devices or dedicated receiver units for this purpose. Remote receiver 140 converts the data signal from the transmitter 130 and provides a visual display of the vehicle occupancy and restraint status. Transmitter 130 and remote receiver 140 allows law enforcement officers or first responders to obtain occupancy and restraint status information when light panel 120 is damaged, disabled or simply not visible.

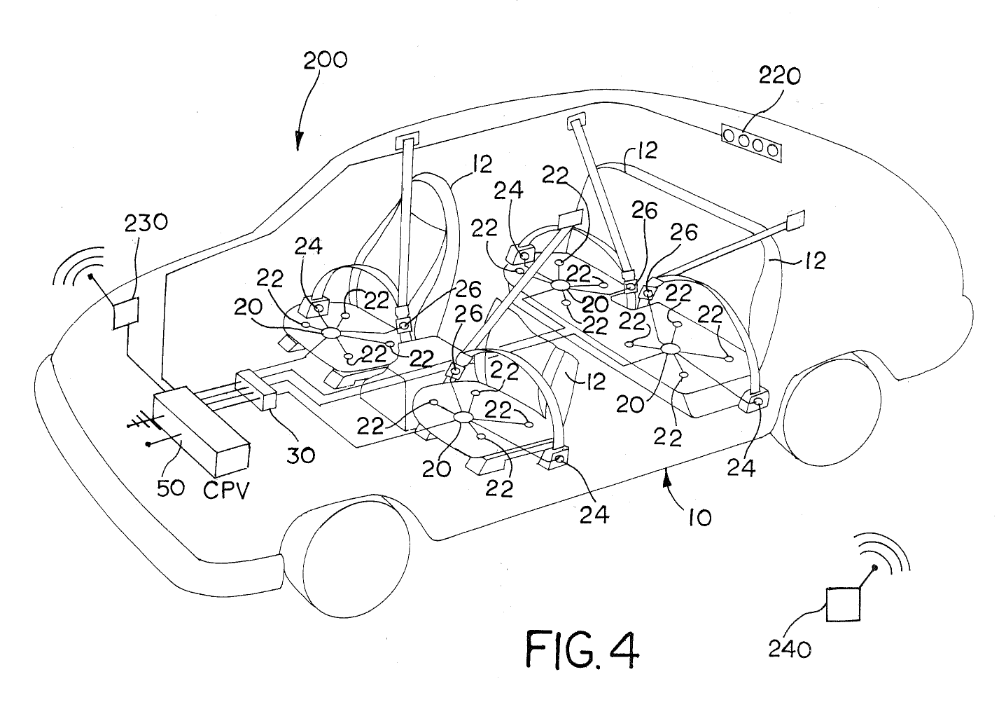

FIGS. 4-6 show an alternative embodiment of the ORSIS of this invention, which is designated generally as reference numeral 200. ORSIS 200 is similar to the first embodiment of ORSIS 100 described above, but the logic control circuitry of the ORSI module, which is represented as reference numeral 210, is incorporated directly into the main logic circuitry or microprocessor controller 50 as an integrated part of the vehicle's main electrical system. Again, ORSIS 200 uses the electrical signals from the pressure and restraint sensors of the vehicle's RCM 20 and OCS 30. The outputs of RCMs 20 and OCS 40 are wired to the main controller. Light panels 220 and the optional transmitter 230 are then wired to signal outputs from controller 50. Controller 50 uses specific embedded firmware and software to process the electrical signals from the pressure and restraint sensors from each RCM 20 and OCS 30 and then sends an electrical signal to light panel 220, which visually display the occupancy and restraint status and/or to transmitter 230, which transmits the status to remote receiver 240 that displays the status.

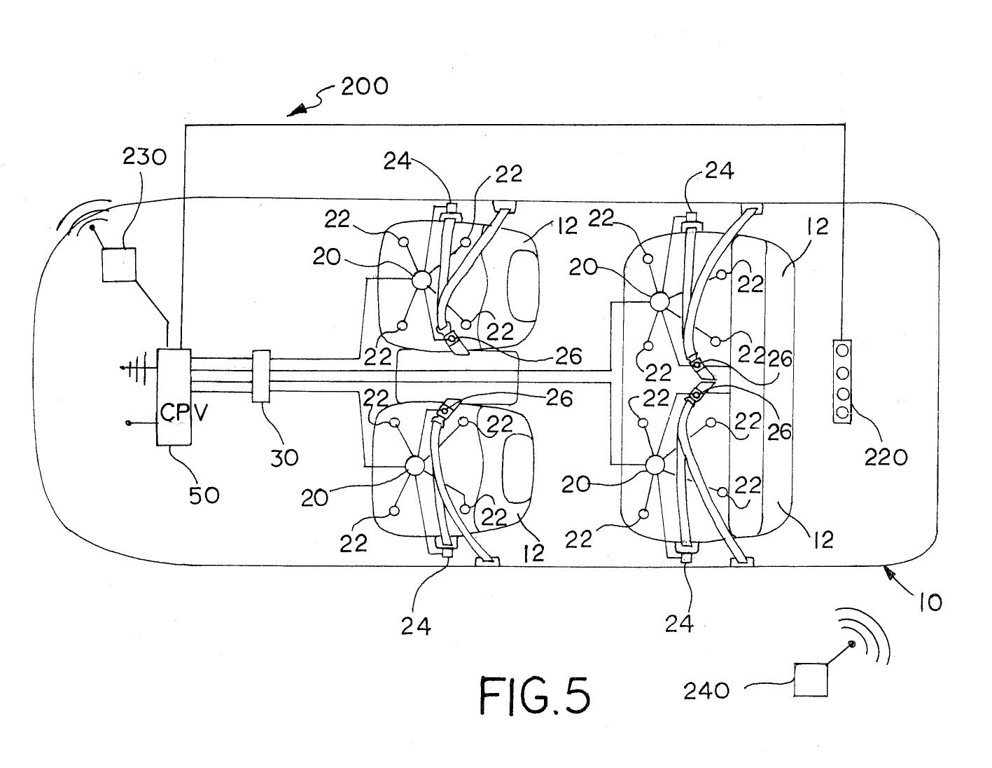

FIG. 5 shows an alternative embodiment of the ORSIS of this invention, which is designated generally as reference numeral 300. ORSIS 300 is similar to the first embodiment, but the control module 310 is operatively connected to the vehicles sound system 60 and includes an internal receiver 360, which received signals from external transponders 62 that are activated by first responders or law enforcement personnel. These type of external transponders are typically used in emergency and police vehicles to over ride traffic lights. Generally, transponder 62 sends a signal to a receiver connected to the traffic lights controller, which interrupts the normal operation of the light and allows the vehicle to proceed under a green light uninterrupted. Receiver 360 of ORSIS 300 detects any signal from an emergency transponder 62 and either disrupts power to sound system 60 or simply mutes the sound for the system. Disrupting or mute sound system 60, enhances the driver's ability to hear any sirens and gives an audible indication of the proximity of a critical situation.

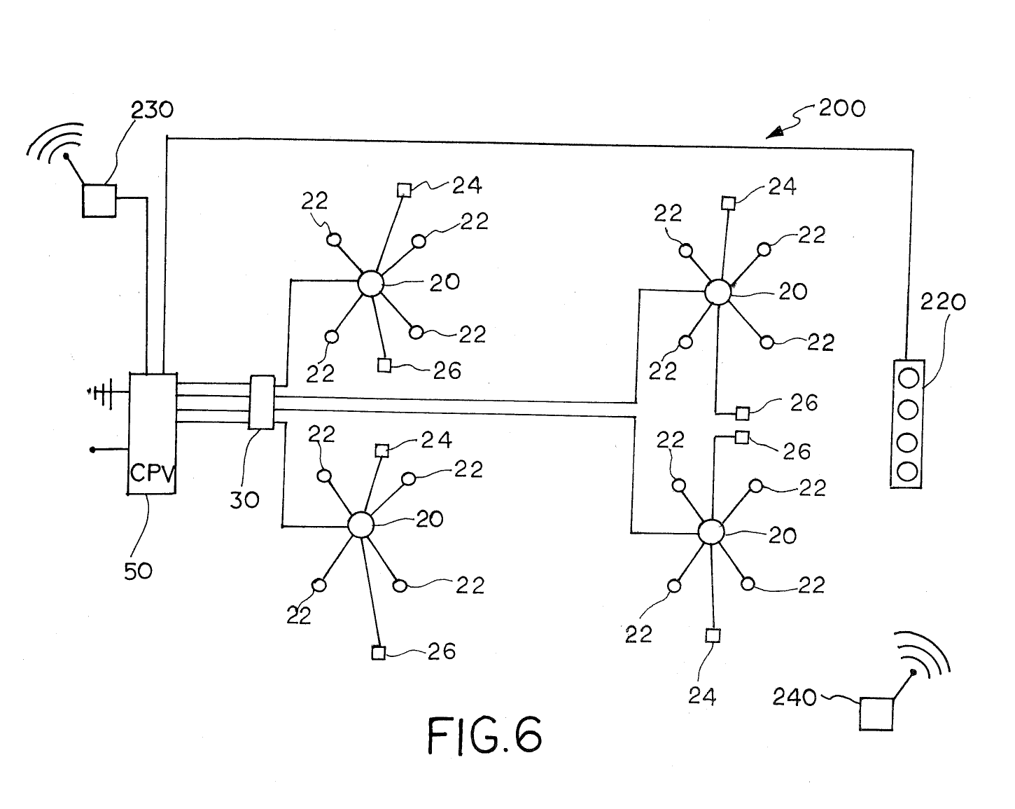

FIG. 6 shows an embodiment of ORSIS of this invention, which is designated generally as reference numeral 400. ORSIS 400 is similar to the first embodiment, but the ORSI module 410 is operatively connected to the vehicles internal telecommunication system 70 and includes a means for selectively disabling the telecommunication system. The function of selectively disabling the telecommunication systems is embedded in the firmware and circuitry of the ORSI module 410. ORSI module 410 may includes a switch, toggle, key or other suitable mechanism for selectively enabling or disabling telecommunication system 70, or may use a remote device of various types suitable for such purposes. ORSIS 400 may also include a telecommuniation disruption or jamming device, that disrupts or block cell phone service or otherwise blocks the use of cell phones and the like within the vehicle while the vehicle is moving. Again, ORSI module 410 is operatively connected to the vehicles main electrical system. ORSI module 410 is programmed to disrupt the telecommunication system and/or jam any cell phone signal while the vehicle is in motion, but restores all telecommunication functions when the vehicle is parked or turned off. Disabling the telecommunication system and jamming any cell phone signals prevents the occupants from being distracted by the use of such devices while the vehicle is moving.

One skilled in the art will note that occupancy and restraint status indicator systems of this invention, provide a higher level of personal safety to law enforcement personnel and first responders. The ORSIS gives the officer or first responder a visual indication of the seat location of each occupant of a vehicle without approaching the vehicle. The ORSIS gives a visual indication that all or any of the occupants are wearing their safety restraints. Additional features can be incorporated into the system which enhance the driver's situational awareness, by automatically muting the vehicle sound system when emergency vehicles are approaching. Additional system components can be incorporated so that the system can selectively block telecommunication signals, which are a source of driver distractions. All of these features are packaged into electrical components and circuitry that can be wired into the vehicle's existing electrical system as an add-on accessory or directly integrated into the electrical system as an OEM feature.

The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1. In a vehicle having a plurality of seats and a safety restraint for each of the plurality of seats, an electrical system for externally indicating the occupancy status and the status of the safety restraints comprising:
a first sensor mounted to each of the plurality of seats for detecting when a person is seated in the seat;
a second sensor mounted to the safety restraint of each of the plurality of seats for detecting when the restraint is activated;
a module connected to the first sensor and the second sensor of each of the plurality of seats for determining the occupancy of each of the plurality of seats and the status of the safety restraints of each of the plurality of seats; and
a display panel connected to the control module and mounted to the vehicle for displaying the occupancy of each of the plurality of seats and the status of the safety restraints of each of the plurality of seats.

2. The electrical system of claim 1 and remote receiver for displaying the occupancy of each of the plurality of seats and the status of the safety restraints of each of the plurality of seats and a transmitter connected to module for sending a signal to the remote receiver.

3. The electrical system of claim 1 and a receiver for detecting signals emitted from emergency vehicles and means responsive to the receiver for indicating the presence of the emergency vehicle in proximity to the vehicle.

4. The electrical systems for Claim and means for disabling the use of telecommunication equipment inside the vehicle when the when is moving.
